(19) United States
(12) Patent Application Publication
(10) Pub. No.: US 2014/0060542 A1
(43) Pub. Date: Mar. 6, 2014

(54) BLOWER FILTER DEVICE OF A BLOWER FILTER SYSTEM AS WELL AS BLOWER FILTER SYSTEM

(71) Applicant: Drager Safety AG & Co. KGaA, Lubeck (DE)

(72) Inventors: Achim VOLMER, Lubeck (DE); Mirco FRÖSCH, Stockelsdorf (DE); Olaf BALKE, Reinfeld (DE)

(73) Assignee: Dräger Safety AG & Co. KGaA, Lubeck (DE)

(21) Appl. No.: 14/013,570

(22) Filed: Aug. 29, 2013

(30) Foreign Application Priority Data
Aug. 30, 2012 (DE) 10 2012 017 176.5

(51) Int. Cl. A62B 9/00; A62B 7/12; A62B 7/02; A62B 7/10

(52) U.S. Cl. CPC A62B 9/00; A62B 7/10; A62B 7/12; A62B 7/02
USPC 128/205.23; 96/424; 128/205.25

(57) ABSTRACT

A blower filter device (1) is provided for a blower filter system (20). The blower filter device (1) has at least one filter (2), a fan wheel (4) arranged in a fan housing (3), a motor (5) for driving the fan wheel (3) as well as a control unit (6) for actuating motor (5) and for processing device-specific parameters of the blower filter device (1). The blower filter device (1) has a housing (13) with a mounting slot (14) for a communication interface module (7). The contact point (15) is arranged in mounting slot (14) for the data-communicating connection of communication interface module (7) to the control unit (6). The blower filter system (20) includes such a blower filter device (1) and, a head piece (21) and a flexible connection hose (22) providing a fluid-communicating connection between the blower filter device (1) and the head piece (21).

### CROSS REFERENCE TO RELATED APPLICATIONS

This application claims the benefit of priority under 35 U.S.C. §119 of German Patent Application DE 10 2012 017 176.5 filed Aug. 30, 2012, the entire contents of which are incorporated herein by reference.

### FIELD OF THE INVENTION

The present invention pertains to a blower filer device for a blower filter system, having at least one filter, a fan wheel arranged in a fan housing, a motor for driving the fan wheel, as well as a control unit for actuating the motor and for processing device-specific parameters of the blower filter device. The present invention pertains, furthermore, to a blower filter system, having a blower filter device, a head piece and a flexible connection hose, which connects the blower filter device and the head piece to one another in a fluid-communicating manner.

### BACKGROUND OF THE INVENTION

Blower filter systems are used for light and medium respiratory protection devices and support the user of respirator filters by lowering the respiration resistance, contrary to conventional gas masks, and thus make long-term fatigue-free use possible. A blower filter system comprises the following principal components: A blower filter device worn usually on the belt and a head piece, which is designed as a hood or mask. These two components are usually connected to one another via a flexible hose. The contaminated air is drawn in by means of a blower filter device through a filter, as a result of which it is freed from harmful substances, and is subsequently sent via a flexible hose to the head piece and is fed to the user of the respiratory protection device. The blower filter device itself comprises, among other things, a fan wheel driven by a motor and a scroll case. The energy for the blower unit is usually supplied by a battery. In addition, there exists a central control unit, which controls the motor of the blower unit and can process inputs of the user. The housing encloses, in general, the blower unit, control unit and battery. At least one filter can be connected to the housing. Besides the main function of transporting air, the blower filter device additionally informs the user of the current operating state as well as cases of defect by visual or acoustic signals.

Reliable function of the blower filter system is of vital significance for the user of the respirator. The information on a malfunction of the blower filter device must therefore also reach the user reliably. Depending on the use conditions, the user is, however, hardly able due to the given environmental situation to perceive visual signals when carrying the device on the back or even acoustic signals in situations with high noise level.

In addition, blower filter devices are designed such that they reach the longest possible service lives for conventional applications and have only minimal weight. Therefore, they often have only a low level of modularity. It is often possible to vary the filters and batteries only.

### SUMMARY OF THE INVENTION

An object of the present invention is to eliminate the above-described drawbacks in blower filter devices for blower filter systems or in blower filter systems at least partially. In particular, it is the object of the present invention to create a highly modular blower filter system, which can both be expanded by functionalities, especially by a connection of an alarming and informing unit, rapidly and in a simple manner depending on the needs.

The above-described object is accomplished by a blower filter device, having the features of the invention as well as by a blower filter system having the features of the invention. Further features and details of the present invention appear from the specification and drawings. Features and details that are described in connection with the blower filter device according to the present invention also apply, of course, in connection with the blower filter system according to the present invention and vice versa, so that reference is or can always mutually be made to the individual aspects of the present invention concerning the disclosure.

According to a first aspect of the present invention, the object is accomplished by a blower filter device for a blower filter system, having at least one filter, a fan wheel arranged in a fan housing, a motor for driving the fan wheel as well as a control unit for actuating the motor and for processing device-specific parameters of the blower filter device. The blower filter device is characterized in that the blower filter device has a housing with a mounting slot for a communication interface module, wherein a contact point (comprising one or more contacts) is arranged in the mounting slot for the data-communicating connection of the communication interface module with the control unit.

The modularity of the blower filter device is increased by such a blower filter device. In particular, such a blower filter device makes it possible to expand the functionalities of the blower filter device in a simple manner and rapidly. Thus, a communication interface module can be inserted into the mounting slot in a simple manner and rapidly and connected there to the contact point for the data-communicating connection of the communication interface module with the control unit. The addition of the communication interface module makes it possible to connect additional functionalities, especially an alarming and informing unit, in a simple manner and rapidly. The modular design makes it possible for users of a blower filter system, who must rely on an additional alarming and informing unit based on the environmental situation, to retrofit the mounting slot, also called module slot, with a communication interface module. Minimization of the weight of the blower filter system is additionally achieved with this possibility of optionally arranging the communication interface module at the blower filter device when the additional functionality, especially the alarming and status display or the alarming and informing unit, is not needed. This means that the additional weight of the communication interface module is present only when needed at the blower filter device or at the blower filter system.

If the communication interface module were permanently installed at the blower filter device, this would require, moreover, an increase in the battery capacity of the blower filter device and hence an increase in the blower filter device at equal service life. This drawback is avoided for the user in case of the modular design being presented without the communication interface module attached.

A blower filter device of such a design of a blower filter system makes it possible for a communication interface module to be able to be inserted optionally into the mounting slot in the housing of the blower filter device. Due to the fact that the communication interface module can be arranged in the mounting slot, this module is protected from external effects, especially shocks, and it guarantees as a result durable functionality. If, for example, no additional alarming and informing system is necessary in the blower filter system for application technical reasons, the communication interface module can be omitted, so that the blower filter device has, on the one hand, a lower weight and, on the other hand, a smaller battery is needed, which in turn leads to a reduction of the weight of the blower filter device.

The blower filter device of the blower filter system may have one or more filters. Instead of a fan wheel, it is, of course, also possible to use other suction systems in order to suction ambient air and to purify it through the at least one filter arranged upstream. The motor of the blower filter device may be preferably driven by means of a battery. However, it is also conceivable that power is supplied via a cable to the blower filter device. The control unit of the blower filter device is used, on the one hand, to actuate the motor and, furthermore, to process the device-specific parameters of the blower filter device. The control unit preferably has a memory unit, in which data and device-specific parameters, especially software for operating the blower filter system, are stored.

The communication interface module may have a physical interface for connecting a cable. A signal can thus be transmitted via a cable from the communication interface module to an alarming and informing system, which is preferably arranged at a head piece of the blower filter system. According to a preferred variant of the present invention, provisions may be made in a blower filter device for the communication interface module to have a wireless interface. The wireless interface may be designed according to the various prior-art standards. For example, a Bluetooth interface, a ZigBee interface, an ANT+ interface or another wireless interface may be provided. The advantage of a wireless interface is that the transmission of data is sometimes possible over great distances. In particular, no interfering cable, which may represent a hindrance for the user of the blower filter device, is present.

Provisions may advantageously be made in a blower filter device for the mounting slot to be designed for receiving the communication interface module in a positive-locking and/or non-positive manner. It is ensured hereby that the communication interface module can be held securely in the mounting slot. For example, the mounting slot can thus be designed such that the communication interface module can be led exactly to the contact point in order to establish a data-communicating connection with the control unit. Especially preferred is a blower filter device in which at least one locking or clamping element is provided in the mounting slot for fastening the communication interface module in a non-positive manner. This locking or clamping element is arranged such that the communication interface module can be held in contact with the contact point of the mounting slot. Other possibilities of fastening are, of course, conceivable as well.

According to an especially preferred variant of the present invention, provisions may be made in a blower filter device for the mounting slot to be additionally designed to receive a battery. As a result, only one mounting slot is necessary for receiving two components, namely, the battery and the communication interface module. This also saves the space needed for installation, besides the manufacturing costs for such a blower filter device. Especially preferred is a blower filter device in which the mounting slot is designed such that the communication interface module is covered in the installed state in the mounting slot by the battery. The battery may be used as a closing element for closing the mounting slot. It is advantageous, in particular, if the battery sealingly covers and closes the mounting slot. The battery or the mounting slot may have a sealing element, especially a circular rubber seal, for this. As a result, the communication interface module as well as the mounting slot itself are better protected from environmental conditions. The robustness of the blower filter device is increased thereby. At the same time, the modular character of the blower filter device is maintained. It is ensured by the arrangement of the communication interface module, which is covered by the battery of the blower filter device in the installed state, that the communication interface module is arranged immovably at the blower filter device, especially in the mounting slot of the blower filter device. It is ensured hereby that the functionality of the communication interface module can be durably maintained.

According to another preferred variant of the present invention, provisions may be made in a blower filter device for a closing element to be arranged for covering the mounting slot at the housing. The closing element may be arranged, for example, in a displaceably or pivotably movable manner at the housing of the blower filter device. Sealing of the mounting slot against environmental effects is guaranteed by the closing element, which is designed especially as a cover. The closing element may be provided in a mounting slot, which is designed only to receive the communication interface module. The closing element may likewise be provided in a mounting slot that is designed both to receive the communication interface module and to receive a battery, especially a battery pack. The closing element preferably has seals for securely sealing the mounting slot when the closing element covers the mounting slot. The robustness of the blower filter device is increased by this even more. At the same time, the mounting slot and/or the battery can be easily removed from the mounting slot by simply pushing up or pivoting the closing element. The closing element is preferably used as a locking or clamping element to fix the communication interface module and/or the battery within the mounting slot. If a closing element is present, additional locking or clamping elements for fixing the communication interface module or the battery within the mounting slot may be omitted.

According to a second aspect of the present invention, the object is accomplished by a blower filter system, having a blower filter device, a head piece and a flexible connection hose, which connects the blower filter device and the head piece to one another in a fluid-communicating manner. The blower filter device is designed now according to the first aspect of the present invention. Such a blower filter system has a high modularity. In particular, simple and rapid expansion of the functionalities of the blower filter system, especially of the blower filter device, is possible in such a blower filter system. The same advantages that were described in detail according to the first aspect in connection with the blower filter device apply to the blower filter system.

The blower filter system preferably has a carrying system, especially a belt, which makes it possible for the blower filter device to be able to carried easily by a user. In particular, a belt, on which the blower filter device is arranged, makes easy carrying possible in any working environment. Especially helmets, hoods, visors or masks may be used as the head piece. An air stream, which is exactly adapted to the individual needs and can be freely regulated depending on application for helmets, hoods, visors and masks, can be fed to the head piece from the blower filter device via the flexible connection hose. Furthermore, a user interface, especially a multifunction control panel, via which the user of the blower filter system can make individual settings on the blower filter system and a detector (such as one or more sensors) for detecting one or more parameters, may be associated with the blower filter device. According to a preferred variant of the present invention, provisions may be made for the blower filter system to have an alarming and informing unit, which has a physical interface for connecting a cable or a wireless interface for receiving data from the communication interface module. The wireless interface advantageously corresponds to the wireless interface of the communication interface module. Thus, a Bluetooth interface, a ZigBee interface or an ANT+ interface may be provided as the wireless interface here as well. Depending on the needs, an alarm or other information of the blower filter device can be displayed to the user of the blower filter system by the alarming and informing unit and it can thus be ensured that the user is informed of the status of the blower filter device, which status is of vital importance to him.

Especially preferred is a blower filter system in which the alarming and informing unit is arranged at the head piece. In particular, the alarming and informing unit is arranged at the head piece such that this is in the field of view of the user, so that he can perceive alarms and information visually. The head piece may preferably have an insertion slot for receiving the alarming and informing unit in a positive-locking and/or nonpositive manner. This makes it possible that the alarming and informing unit can also be added to the blower filter system as a module. If such an alarming and informing unit is not necessary, it can be removed from the insertion slot of the head piece simply by removing the alarming and informing unit.

The blower filter system according to the present invention has a higher modularity than prior-art blower filter systems. Depending on the needs, an alarming and informing unit can be added to the blower filter system due to the modular design. Furthermore, the communication interface module must be arranged at the contact point within the mounting slot to transmit data to the alarming and informing unit. If no alarming and informing unit is needed, this as well as the communication interface module may be omitted, as a result of which the weight of the blower filter system decreases markedly. At the same time, the battery of the blower filter system or of the blower filter device may also be dimensioned smaller, because less capacity is needed if no communication interface module is provided.

The present invention will be explained in more detail on the basis of the drawing figures attached. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic perspective view showing a blower filter system having a blower filter device, a head piece as well as a flexible connection hose;

FIG. 2 is a schematic view showing a blower filter device of a blower filter system, which is designed according to the design principle according to the present invention;

FIG. 3 is a schematic view showing another blower filter device of a blower filter system, which is designed according to the design principle according to the present invention; and

FIG. 4 is a schematic view showing a blower filter system with a blower filter device, with a head piece and with a flexible connection hose, wherein the blower filter system is designed according to the design principle according to the present invention.

### DESCRIPTION OF THE PREFERRED EMBODIMENTS

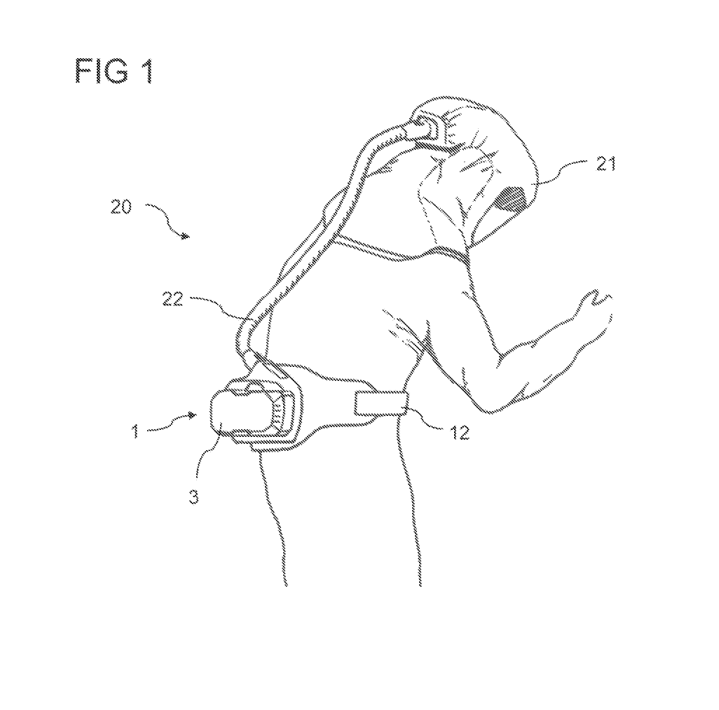

Referring to the drawings in particular, elements having the same function and mode of action are always designated by the same reference numbers in FIGS. 1 through 4.

FIG. 1 schematically shows a blower filter system 20, having a blower filter device 1, a head piece 21 as well as a flexible connection hose 22, which connects the blower filter device 1 and the head piece 21 to one another in a fluid-communicating manner. Blower filter device 1 is arranged on a carrying system 12 in the form of a belt, so that easy carrying is possible for a user in any working environment. Blower filter device 1 has a fan housing 3, in which a fan wheel 4 is arranged.

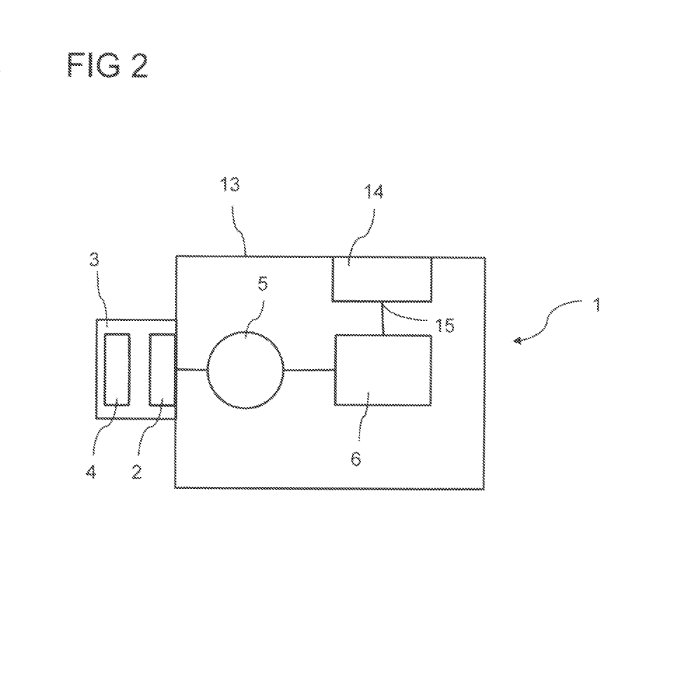

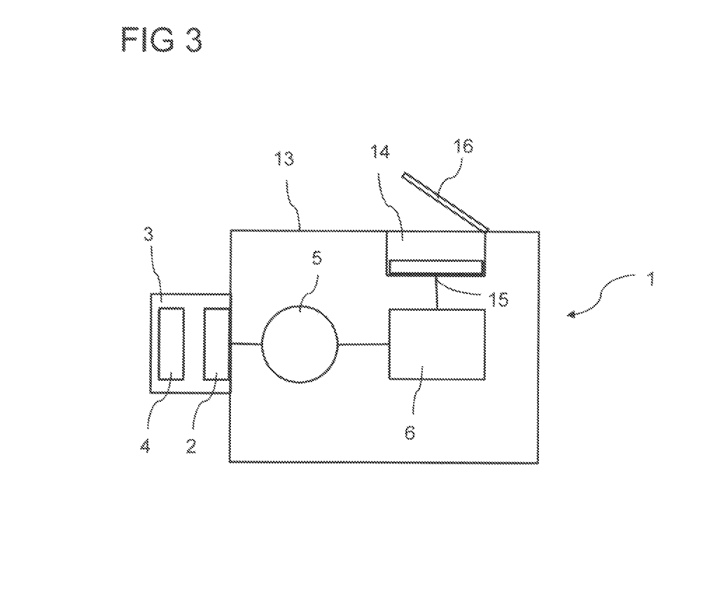

FIG. 2 schematically shows a blower filter device 1 of a blower filter system 20, which is designed according to the design principle according to the present invention. Blower filter device 1 has a fan wheel 4, which is arranged in a fan housing 3 and is driven by a motor 5. A filter 2, which purifies the ambient air suctioned by the fan wheel 4, is arranged upstream of the fan wheel 4. A control unit 6, which also processes device-specific parameters of the blower filter device 1, is provided for actuating motor 5. Blower filter device 1 has, furthermore, a housing 13, in which the components of the blower filter device 1 are arranged. The fan housing may be part of the housing 13, in the form of a sub housing. A mounting slot 14 for a communication interface module 7 of the blower filter device 1 is provided in housing 13. A contact point 15 for the data-communicating connection of the communication interface module 7 with the control unit 6 is arranged in mounting slot 14, especially at the bottom of mounting slot 14. The contact point 15 may comprise one or a plurality of electrical contacts which make electrical connection to one or a plurality of electrical contacts provided on the communication interface module 14. FIG. 3 shows the arrangement of the communication interface module 7 of the blower filter device 1 within mounting slot 14. Communication interface module 14 may be arranged within the mounting slot 14 in a positive-locking and/or non-positive manner. Locking or clamping elements are preferably provided for the non-positive fastening of the communication interface module 7 in mounting slot 14. Communication interface module 7 may have a physical interface for connecting a cable or a wireless interface. Data can be transmitted to other functionalities via this interface of the communication interface module 7. FIG. 3 shows, furthermore, a closing element 16, here in the form of a pivotable cover, which is arranged on housing 13 to cover the mounting slot 14. As an alternative to a pivotable arrangement of closing element 16 on housing 13, said closing element 16 may be arranged displaceably on housing 13. It is ensured by the closing element 16 that mounting slot 14 is sealed against environmental effects. Furthermore, closing element 16 may be used as a locking or clamping element for fixing the communication interface module 7 within mounting slot 14.

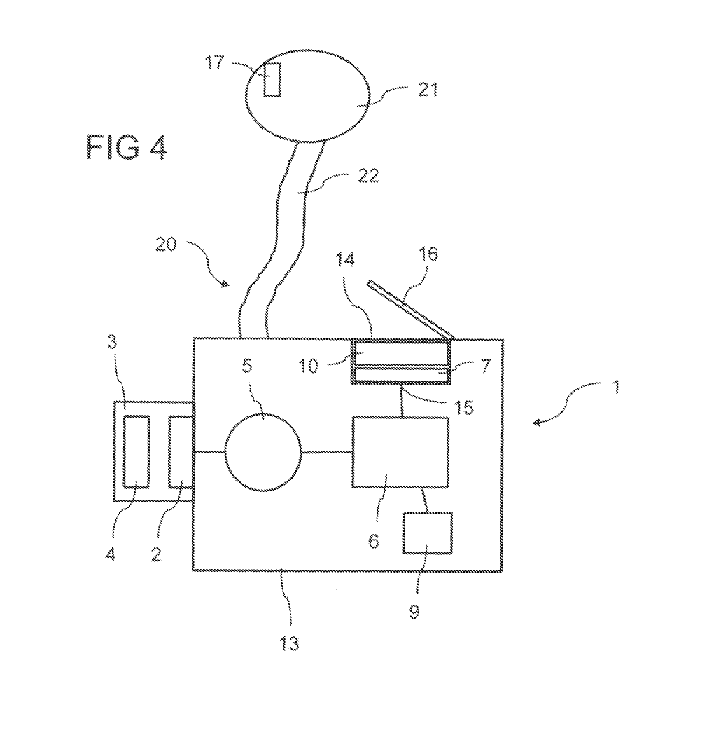

Mounting slot 14 may additionally be designed to receive a battery 10, see FIG. 4. The mounting slot 14 is designed, in particular, such that the communication interface module 7 is covered in the installed state by battery 10. Especially secure arrangement of the communication interface module 7 within the mounting slot 14 is guaranteed hereby. Battery 10 may have a sealing element, such as a circular rubber seal. As a result, battery 10 acts as a closing element and reliably seals mounting slot 14. At the same time, no additional mounting slot or no additional fastening device is necessary for fastening a battery 10 to the housing 13 of blower filter device 1.

The blower filter system 20 according to the present invention shown in FIG. 4 has a blower filter device 1, a head piece 21, which may be designed as a helmet, as a hood, as a visor or as a mask, as well as a flexible connection hose 22, which connects the blower filter device 1 and head piece 21 to one another in a fluid-communicating manner. Blower filter system 20 has a battery 10, which is arranged, just as the communication interface module 7, within a mounting slot 14. Battery 10 is used to operate motor 5 and control unit 6. Due to the battery 10 being arranged within mounting slot 14, simple replacement of the battery is made possible. Battery 10 is easily accessible and can be charged, for example, in the installed state. As an alternative hereto, battery 10 can be easily removed from mounting slot 14 in order to be either replaced or charged outside the blower filter device 1. An alarming and informing unit 17, which preferably has the same physical interface as the communication interface module 17 of blower filter device 1, is arranged in head piece 21. As a result, a signal can be sent in a simple manner from the blower filter device 1 to the alarming and informing unit 17 in head piece 21 in order to thus display alarms and the status of the blower filter device 1 to a user and to ensure that the user is informed of the status of the blower filter device 1, which status is of vital importance to him. The alarming and informing unit 17 is preferably arranged in an insertion slot of head piece 21 in a positive-locking and/or non-positive manner.

A blower filter system 20 of such a design makes it possible to provide a communication interface module 7 as well as an alarming and informing unit 17 in a simple manner and rapidly. If no alarming and informing unit 17 is needed, this as well as the communication interface module 7 can be easily removed in order to thus reduce the weight of the blower filter system.

The above explanation of the embodiments of the blower filter system 20 describes the present invention within the framework of examples. Individual features of the embodiments, if technically meaningful, may, of course, be freely combined with one another without going beyond the scope of the present invention.

While specific embodiments of the invention have been shown and described in detail to illustrate the application of the principles of the invention, it will be understood that the invention may be embodied otherwise without departing from such principles.

What is claimed is:

1. A blower filter device for a blower filter system, the blower filter device comprising:
a filter;
a fan wheel;
a motor driving the fan wheel;
a control unit for actuating the motor and for processing device-specific parameters of the blower filter device;
a blower filter device communication interface module;
a housing with a mounting slot receiving the blower filter device communication interface module; and
a contact point arranged in the mounting slot providing a data-communicating connection of the communication interface module to the control unit.

2. A blower filter device in accordance with claim 1, wherein the blower filter device communication interface module has a physical interface for connecting a cable or has a wireless interface.

3. A blower filter device in accordance with claim 1, wherein the mounting slot is designed to receive the blower filter device communication interface module in a positive-locking and/or non-positive manner.

4. A blower filter device in accordance with claim 1, further comprising a locking or clamping element provided in the mounting slot for a non-positive fastening of the blower filter device communication interface module.

5. A blower filter device in accordance with claim 1, further comprising a battery, wherein the mounting slot is additionally designed to receive the battery.

6. A blower filter device in accordance with claim 5, wherein the mounting slot is designed such that the blower filter device communication interface module is covered in the installed state by the battery.

7. A blower filter device in accordance with claim 1, further comprising a closing element arranged on the housing for closing the mounting slot.

8. A blower filter device in accordance with claim 7, wherein the closing element is arranged on the housing in a displaceably or pivotably movable manner.

9. A blower filter system comprising:
a head piece;
a flexible connection hose; and
a blower filter device comprising a filter, a fan wheel, a motor driving the fan wheel, a control unit for actuating the motor and for processing device-specific parameters of the blower filter device, a blower filter device communication interface module, a housing with a mounting slot receiving the blower filter device communication interface module and a contact point arranged in the mounting slot providing a data-communicating connection of the communication interface module to the control unit, the flexible connection hose connecting the blower filter device and the head piece to one another in a fluid-communicating manner.

10. A blower filter system in accordance with claim 9, further comprising an alarming and informing unit, which has a physical interface for connecting a cable or a wireless interface for receiving data from the blower filter device communication interface module.

11. A blower filter system in accordance with claim 10, wherein the alarming and informing unit is arranged on the head piece.

12. A blower filter system in accordance with claim 11, wherein the head piece has an insertion slot for receiving the alarming and informing unit in a positive-locking and/or non-positive manner.

13. A blower filter device for a blower filter system, the blower filter device comprising:
a filter;
a fan wheel;
a motor driving the fan wheel;
a control unit for actuating the motor and for processing device-specific parameters of the blower filter device;
a blower filter device communication interface module;
a blower filter device housing; and
a blower filter device communication interface module mounting device connected to the blower filter device housing, the mounting device receiving the blower filter device communication interface module and having a contact point providing a data-communicating connection of the communication interface module to the control unit.

14. A blower filter device in accordance with claim 13, wherein the blower filter device communication interface module has a physical interface for connecting a cable or has a wireless interface.

15. A blower filter device in accordance with claim 13, further comprising a locking or clamping element connected to the mounting device for a non-positive fastening of blower filter device communication interface module to the mounting device.

16. A blower filter device in accordance with claim 13, further comprising a battery, wherein the mounting device is additionally designed to receive the battery and includes a battery contact point for electrical connection between the battery and the motor and the control unit.

17. A blower filter device in accordance with claim 16, wherein the mounting device is designed such that the blower filter device communication interface module is covered in an installed state by the battery.

18. A blower filter device in accordance with claim 13, further comprising a closing element arranged on the housing for closing the mounting device.

19. A blower filter device in accordance with claim 18, wherein the closing element is arranged on the housing in a displaceably or pivotably movable manner.

20. A blower filter device in accordance with claim 18, wherein the fan is arranged in a fan housing that is either a part of the blower filter device housing or is a sub housing in the blower filter device housing or connected to the blower filter device housing.
